(19) United States
(12) Patent Application Publication
(10) Pub. No.: US 2006/0211767 A1
(43) Pub. Date: Sep. 21, 2006

(54) Method of combating turf pests with a combination of imidacloprid and bifenthrin

(76) Inventor: Reed N. Royalty, Cary, NC (US)

Correspondence Address: BAYER CROPSCIENCE LP;Patent Department, 100 BAYER ROAD, PITTSBURGH, PA, 15205-9741, US

(21) Appl. No.: 11/085,451

(22) Filed: Mar. 21, 2005

(51) Int. Cl. A01N 53/00

(52) U.S. Cl. 514/531

(57) ABSTRACT

This invention relates to a method of controlling surface insect pests of turf using bifenthrin and imidacloprid.

### BACKGROUND OF THE INVENTION

The present invention relates to the control of turf pests at a locus, particularly a turfgrass locus.

Imidacloprid is an insecticide known to the skilled artisan to control a variety of pests. U.S. Pat. No. 4,742,060 provides a description of imidacloprid and some uses. Imidacloprid is known to control some turf pests, for example, the larvae of Popillia japonica Newm.

Bifenthrin is an insecticide known to the skilled artisan to control a variety of pests. Bifenthrin is generally known as 2-methylbiphenyl-3-ylmethyl (Z)-(1RS,3RS)-3-(2-chloro-3,3,3-trifluoroprop-1-enyl)-2,2-dimethylcyclopropane-carboxylate, CAS Registry Number 82657-04-3. Bifenthrin is described in The Pesticide Manual, p. 88 (entry 76), C. D. S. Thomas, ed., (13^{th} Ed., 2003).

Bifenthrin is known to provide some control of Hemepteran insects of the family Lygaeidae, particularly those known to the skilled artisan as chinch bugs, big-eyed bugs or false chinch bugs. However, the length of control of chinch bugs, particularly the southern chinch bug, Blissus insularis, using bifenthrin may not be completely satisfactory at doses below 0.2 lb Al/A.

An object of the present invention is to provide a new method of controlling some lawn pests, including chinch bugs. Another object of the present invention is to provide a new composition of insecticides to control some lawn pests, including chinch bugs. These and other objects of the invention are met in whole or in part by the means of the present invention.

### SUMMARY OF THE INVENTION

The present invention provides a method of controlling chinch bugs in turfgrass, which method comprises
(a) providing a composition comprising a synergistically effective amount of imidacloprid and bifenthrin, and
(b) applying the composition to the turf.

The present invention also provides a method of controlling surface feeding pests in turf grass in need of chinch bug control comprising applying a composition comprising bifenthrin and imidacloprid at a rate which in one application of the composition provides control that is substantially biologically equivalent to 1.8 to 2.5 applications of bifenthrin at the same rate of application of bifenthrin.

The present invention also provides a composition comprising a synergistically effective amount of imidacloprid and bifenthrin which in use controls chinch bugs in turfgrass.

The present invention also provides a product for the control of chinch bugs which comprises the separate, sequential or simultaneous application of imidacloprid and bifenthrin.

### BRIEF DESCRIPTION OF THE DRAWINGS

FIG. 1 shows test results showing the effectiveness of a soluble composition according to Example 1 on chinch bugs.

FIG. 2 shows test results showing the effectiveness of a granular composition according to Example 1 on southern and tawny mole crickets.

### DETAILED DESCRIPTION OF THE INVENTION

Generally, imidacloprid and bifenthrin are admixed to form the composition. The composition may be a solid or liquid composition according to the knowledge of the skilled artisan. Examples of suitable compositions include granules, dusts, powders, and wettable powders. Suitable liquids include emulsifiable concentrates, solutions, flowables, suspension concentrates and suspensions.

The amount of active ingredients in the composition of the invention can vary widely but is generally from about 0.1% to about 95% of active ingredient. (Percents are generally percent by weight in the current specification and claims of the present application unless otherwise denoted.) Preferably, the ratio of the amount of bifenthrin to the amount of imidacloprid is from about 1:5 to about 4:6. The amount of bifenthrin and imidacloprid in a soluble concentrate formulation varies from about 2% to about 4% and from about 4 about 5%, respectively. The amount of bifenthrin and imidacloprid in granular formulations varies from about 0.1 to about 0.2% and from about 0.125 to about 0.25%, respectively.

The remainder of the composition up to 100% comprises a carrier as well as various additives such as those hereafter indicated. By “carrier”, there is meant herein an organic or inorganic material, which can be natural or synthetic and which is associated with the active ingredient and which facilitates its application to the locus to be treated or crop. This carrier is thus generally inert and should be agriculturally acceptable, especially on the contemplated or treated locus or crop. The carrier can be solid (for example, clay, silicates, silica, resins, wax, fertilizers, or the like) or liquid (for example, water, alcohols, ketones, oil solvents, saturated or unsaturated hydrocarbons, chlorinated hydrocarbons, liquified petroleum gas, or the like).

Among the many additives, the compositions of the invention can comprise surfactants as well as other ingredients such as dispersants, stickers, antifoam agents, antifreezing agents, dyestuffs, thickeners, adhesives, protective colloids, penetrating agents, stabilizing agents, sequestering agents, antiflocculating agents, corrosion inhibitors, pigments and polymers.

More generally, the compositions of the invention can comprise all kinds of solid or liquid additives which are known in the art of insecticides and insecticidal treatments.

The surfactants can be of the emulsifying or wetting type, ionic or non-ionic. Possible surfactants are salts of polyacrylic or lignosulfonic acids; salts of phenolsulfonic or naphthalenesulfonic acids; poly-condensates of ethylene oxide with fatty alcohols or fatty acids or fatty amines or substituted phenols (particularly alkylphenols or arylphenols); ester-salts of sulfosuccinic acids; taurine derivatives, such as alkyl taurates; phosphoric esters; or esters of alcohols or polyoxyethylated phenols. When the spraying vehicle is water, the use of at least one surfactant is generally employed.

Imidacloprid is generally used at from about 450 to about 800 g/ha and bifenthrin from about 220 to about 450 g/ha to control mole crickets. Both active ingredients must be applied during peak egg hatch to be effective, and even then the control obtained is inconsistent and often not commercially acceptable.

Therefore, according to the invention, imidacloprid is generally used at from about 330 to about 450 g/ha and bifenthrin from about 100 to about 220 g/ha to control chinch bugs. At these doses, the efficacy of imidacloprid alone often is inconsistent, particularly against southern chinch bug (Blissus insularis). At doses below 220 g/ha of bifenthrin alone, the level and residuality of control of southern chinch bug also is inconsistent and insufficient.

The present invention can be practiced with all turfgrasses, including cool season turfgrasses and warm season turfgrasses. Examples of cool season turfgrasses are bluegrasses (Poa spp.), such as Kentucky bluegrass (Poa pratensis L.), rough bluegrass (Poa trivialis L.), Canada bluegrass (Poa compressa L.), annual bluegrass (Poa annua L.), upland bluegrass (Poa glaucantha Gaudin), wood bluegrass (Poa nemoralis L.), and bulbous bluegrass (Poa bulbosa L.); the bentgrasses and redtop (Agrostis spp.), such as creeping bentgrass (Agrostis palustris Huds.), colonial bentgrass (Agrostis tenuis Sibth.), velvet bentgrass (Agrostis canina L.), South German Mixed Bentgrass (Agrostis spp. including Agrostis tenius Sibth., Agrostis canina L., and Agrostis palustris Huds.), and redtop (Agrostis alba L.); the fescues (Festucu spp.), such as red fescue (Festuca rubra L. spp. rubra), creeping fescue (Festuca rubra L.), chewings fescue (Festuca rubra commutata Gaud.), sheep fescue (Festuca ovina L.), hard fescue (Festuca longifolia Thuill.), hair fescue (Festucu capillata Lam.), tall fescue (Festuca arundinacea Schreb.), meadow fescue (Festuca elanor L.); the ryegrasses (Lolium spp.), such as annual ryegrass (Lolium multiflorum Lam.), perennial ryegrass (Lolium perenne L.), italian ryegrass (Lolium multiflorum Lam.); and the wheatgrasses (Agropyron spp.), such as fairway wheatgrass (Agropyron cristatum (L.) Gaertn.), crested wheatgrass (Agropyron desertorum (Fisch.) Schult.), and western wheatgrass (Agropyron smithii Rydb.). Other cool season turfgrasses include beachgrass (Ammophila breviligulata Fern.), smooth bromegrass (Bromus inermis Leyss.), cattails such as Timothy (Phleum pratense L.), sand cattail (Phleum subulatum L.), orchardgrass (Dactylis glomerata L.), weeping alkaligrass (Puccinellia distans (L.) Parl.) and crested dog's-tail (Cynosurus cristatus L.).

Examples of warm season turfgrasses include Bermudagrass (Cynodon spp. L. C. Rich), zoysiagrass (Zoysia spp. Willd.), St. Augustine grass (Stenotaphrum secundatum Walt Kuntze), centipedegrass (Eremochloa ophiuroides Munro Hack.), carpetgrass (Axonopus affinis Chase), Bahia grass (Paspalum notatum Flugge), Kikuyugrass (Pennisetum clandestinum Hochst. ex Chiov.), buffalo grass (Buchloe dactyloids (Nutt.) Engelm.), Blue gramma (Bouteloua gracilis (H. B. K.) Lag. ex Griffiths), seashore paspalum (Paspalum vaginatum Swartz) and sideoats grama (Bouteloua curtipendula (Michx. Torr.). St. Augustine grass and Bermudagrass are the most preferred.

The following examples further illustrate details for the preparation and use of the compositions of this invention. The invention, which is set forth in the foregoing disclosure, is not to be limited either in spirit or scope by these examples. Those skilled in the art will readily understand that known variations of the conditions and processes of the following preparative procedures can be used to prepare these compositions.

### EXAMPLES

### Example 1

The products Allectus™ GC Granular and Allectus™ GC SC were created by making a formulation of imidacloprid and bifenthrin. The products were made as a granular formulation and a suspension concentrate, respectively, by methods known to those of skill in the art.

### Example 2

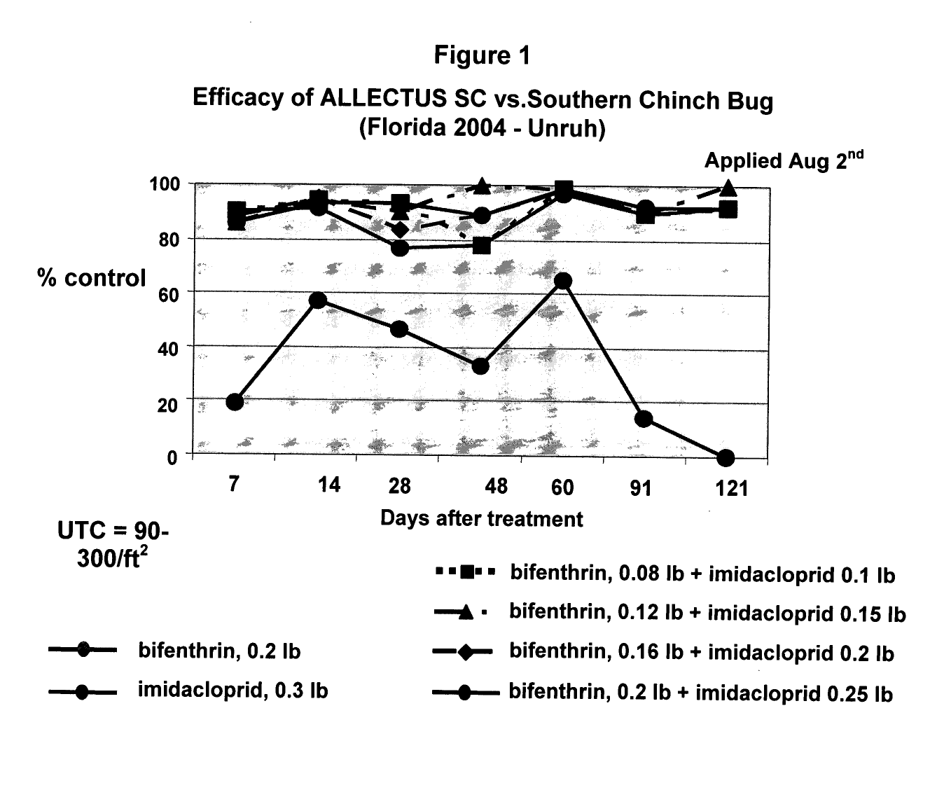

The following test was performed to show the effectiveness of Example 1 on chinch bugs. The formulations tested were the soluble concentrate of Allectus GC SC product described in Example 1. FIG. 1 shows the results. The residual control obtained from the coformulation at doses resulting in application of 89 g/ha of bifenthrin plus 111 g/ha of imidacloprid, and of 133 g bifenthrin plus 167 g/ha imidacloprid is comparable to the control obtained with 222 g/ha of bifenthrin, and greatly superior to the control obtained with 330 g/ha of imidacloprid.

### Example 3

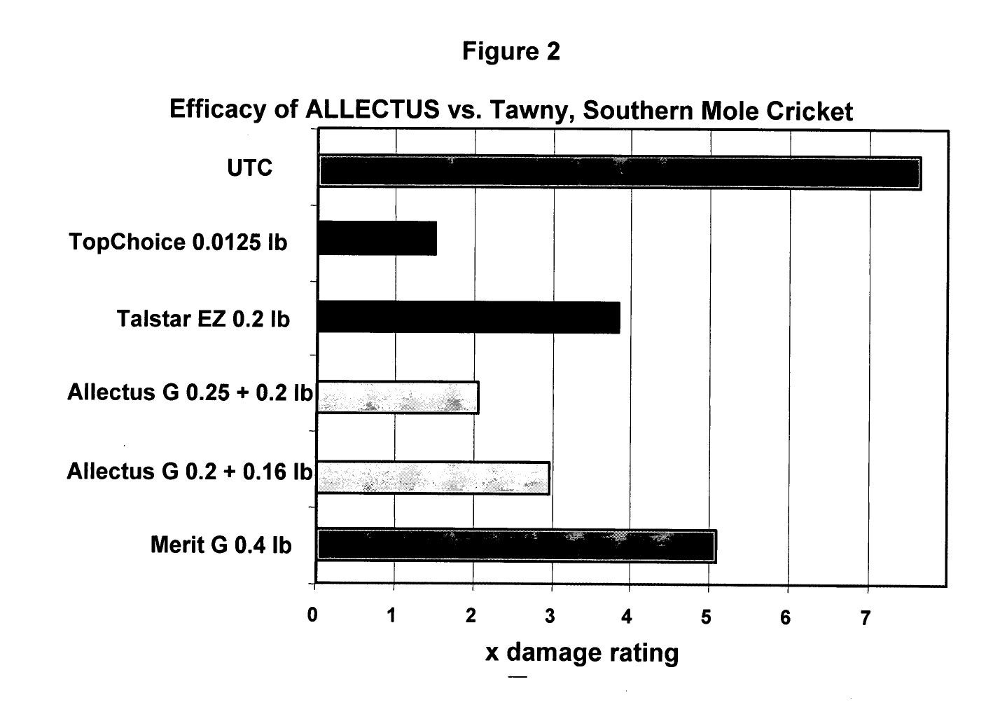

The following test was performed to show the effectiveness of Allectus GC Granulate on southern and tawny mole crickets. The crickets were large nymphs, whereas the normal application timing for topically applied mole cricket products is at peak egg hatch (i.e., two months earlier in the season than the date on which this study began. FIG. 2 shows the results. The level of control provided by a granular formulation of the combination product in Example 1, applied at doses that deliver 222 g/ha of bifenthrin plus 278 g/ha imidacloprid and 178 g/ha bifenthrin plus 222 g/ha imidacloprid, provided mole cricket control greatly superior to 222 g/ha of bifenthrin or by 450 g/ha imidacloprid, as measured on a non-linear 0-9 grid scale.

What is claimed is:

1. A method of controlling chinch bugs in turfgrass, which method comprises
(a) providing a composition comprising a synergistically effective amount of imidacloprid and bifenthrin, and
(b) applying the composition to the turf.

2. A method of controlling surface feeding pests in turf grass in need of chinch bug control comprising applying a composition comprising bifenthrin and imidacloprid at a rate which in one application of the composition provides control that is substantially biologically equivalent to 1.8 to 2.5 applications of bifenthrin at the same rate of application of bifenthrin.

3. A composition comprising a synergistically effective amount of imidacloprid and bifenthrin which in use controls chinch bugs in turfgrass.

4. The method of claim 1 wherein the amount of bifenthrin is from 40 g/ha to 220 g/ha.

5. The method of claim 4 wherein the amount of bifenthrin is from 60 g/ha to 150 g/ha.

6. The method of claim 1 wherein the amount of imidacloprid is from 150 g/ha to 330 g/ha.

7. The method of claim 5 wherein the amount of imidacloprid is from 160 g/ha to 200 g/ha.

8. The method of claim 2 wherein the surface feeding insect is mole cricket.

9. The method of claim 8 wherein the amount of bifenthrin is from 150 g/ha to 250 g/ha.

10. The method of claim 8 wherein the amount of imidacloprid is from 200 g/ha to 350 g/ha.
